(19) United States
(12) Patent Application Publication
(10) Pub. No.: US 2024/0036878 A1
(43) Pub. Date: Feb. 1, 2024

(54) METHOD FOR BOOTING AN ELECTRONIC CONTROL UNIT

(71) Applicant: Robert Bosch GmbH, Stuttgart (DE)

(72) Inventors: Prajakta Pandit, Stuttgart (DE); Gautam Pai, Stuttgart (DE)

(21) Appl. No.: 18/350,387

(22) Filed: Jul. 11, 2023

(30) Foreign Application Priority Data
Aug. 1, 2022 (DE) 10 2022 207 941.8

(51) Int. Cl. G06F 9/44

(52) U.S. Cl. CPC G06F 9/44

(57) ABSTRACT

A method for booting an electronic control unit (ECU). The ECU includes a host interacting with a Hardware Security Module (HSM). At least one software component is checked by the HSM, in case a manipulation is detected the host sends a request to HSM to check whether the manipulation has occurred, the host decides whether an intervention is necessary.

### CROSS REFERENCE

The present application claims the benefit under 35 U.S.C. § 119 of German Patent Application No. DE 10 2022 207 941.8 filed on Aug. 1, 2022, which is expressly incorporated herein by reference in its entirety.

### FIELD

The present invention provides for a method for booting an electronic control unit (ECU) and an arrangement for performing said method.

### BACKGROUND INFORMATION

An electronic control module (ECU) is an embedded system, e.g. used in automotive electronics, that controls one or more of the electrical systems in a motor vehicle. Booting is the process of starting a computer initiated by hardware. Booting typically comprises the step of loading software into a memory before it can be executed.

Currently, hardware trust of anchor supports a set of boot options to ensure that only authenticated software is executed on a host. The so-called Hardware Security Module (HSM) is a widely used root of trust in automotive industry. HSM forms a trusted component on the ECU.

A HSM software component is secured to maintain the integrity and confidentiality of its data and code. Thus, the execution of HSM software on the ECU is trusted. This trust is required to be extended onto the host (application software component) to ensure that only authenticated code is executed on the ECU. If a non-authentic software is detected, failure strategies can be defined to contain the damage. This trust can be extended in two ways:

i. Host security mechanisms: Protection mechanisms can be set up in host software component to make the code secured and trusted. Some of said mechanisms include making the software component One-Time-Programmable (OTP), whereby the software component is password protected ensuring that it is not possible to write etc.

ii. HSM security mechanisms: The cryptographic algorithms in HSM are used to verify the authenticity and integrity of the software components before execution. This involves interactions between the Host and HSM to ensure that the code executed is always secure. This mechanism causes a trade-off of increased boot up time. This is due to the reason that the host has to wait until it receives a positive response from the HSM ensuring the security of the software components. This results in an increased ECU boot up time.

The boot sequences involving varied interactions between the host and the HSM currently available and/or implemented are:

i. Secure Boot: HSM software component is the first code that executes on the ECU and which is trusted. HSM begins to verify the security of software components flashed onto the host. The host can only start when HSM has verified the integrity and authenticity of all software components. The host is not involved in these checks and HSM performs them independently and mandatorily. Even though the security provided by this mechanism is significant, it results in an increased ECU boot up time.

ii. Trusted Boot: HSM software component is the first code that executes on the ECU and which is trusted. HSM begins to verify the security of the pre-configured software components flashed onto the host. The host can only start when HSM has verified the integrity and authenticity of some of the software components. The host can later decide to verify the security of remaining software components. Thus, the security is not as remarkable as it is when using Secure Boot. However, the ECU boot up is reduced as HSM does not verify security of all software components.

iii. Authenticated Boot: HSM and the host (trusted software component) start in parallel. For this start-up sequence to work, the first software component starting up on host must be secured by protection mechanisms mentioned above. Once the HSM completely boots up, the host queries the HSM and releases the applications once a confirmation is obtained from HSM about the security of the software. HSM does not independently perform any checks. Thus, the responsibility of ensuring the security falls upon the host and correspondingly to query the HSM to verify the software components.

iv. Autonomous Boot: The host and HSM can start in parallel. The first software component to execute or start-up on the host is protected by the security mechanism on host (OTP, write protected, password protection . . . ). HSM will verify pre-defined software components prior to allowing the host to release applications. The only difference between this mechanism and Authenticated Boot is that HSM needs not to be fully booted. Before HSM completely boots up, it verifies the security of pre-defined software components. HSM performs the checks autonomously without explicit query from the host for the pre-defined software components. Thus, the ECU boot up time is reduced in comparison to the Authenticated Boot option.

Secure Boot provides the better solution in terms of security, but the ECU boot up time is usually unacceptable in automotive industry where the boot up time is a crucial parameter. Thus, it is not a favorable option.

Trusted Boot ensures the security of the defined software parts and serial execution ensures good ECU boot-up time when compared to secure boot as well. However, the security offered is not sufficient as some software components can remain unverified and unauthenticated.

Authenticated Boot and Autonomous Boot provide a trade-off between the security and ECU boot up time by offering parallel boot up sequence. Authenticated Boot puts the task of verification on the host whereas HSM is intermittently involved in the Autonomous Boot. Despite of this trade-off, the boot up time offered in these strategies are still impermissible from OEM (Original Equipment Manufacturer) point of view. This makes it difficult to achieve a sufficiently secure boot up solution with an agreeable ECU boot-up time.

### SUMMARY

According to the present invention, a method for booting an ECU is provided.

Furthermore, an arrangement suitable for performing the method is provided according to the present invention.

The present invention includes a method for booting an electronic control unit (ECU), the ECU comprises a host interacting with a Hardware Security Module (HSM), whereby at least one software component to be executed is checkedby HSM as it is the secure root of trust.

In case a manipulation is detected the host sends a request to HSM to check whether the manipulation has occurred. A manipulation can be detected for example by checking a bit change in memory address range, by checking checksum on corresponding address etc. of the at least one software component. That means that HSM checks authenticity and integrity of the at least one software component. Then host decides whether an intervention is necessary.

In one example embodiment of the present invention, the host queries the HSM to recompute the integrity checks of the affected software component.

Furthermore, in case a manipulation is detected the host can set a flag. This flag can be an array value.

Setting a flag value as an array is one of the example solutions to document manipulation detection. Other mechanisms include other software and/or hardware solutions like using hardware registers to note the manipulation information, use an invalid marker to indicate that the software should be checked again etc. Therefore, basically any sort of indication mechanism from the host side can be used or communication from application to boot software about the manipulation.

The host can request for Run Time Manipulation Detection (RTMD) verification results from HSM. Host only requests for RTMD verification results from HSM. HSM executes/runs RTMD. This can be done automatically by HSM in predefined intervals without an intervention from host, once HSM is in HSM application mode.

According to an example embodiment of the present invention, the method allows for reducing ECU boot up time and ensuring security by a deterministic Authenticated Boot extension.

A further development of the Authenticated Boot sequence is proposed according to an example embodiment of the present invention which helps the host to make informed decision whether to involve HSM during boot up for verification or not. This organized and informed decision-making at the host side reduces the ECU boot up time due to less HSM involvement, alongside ensuring security to prevent execution of manipulated software in current and/or next driving cycle based on the failure strategies.

The arrangement described herein is suitable for performing the method proposed. The arrangement can be implemented in hardware and/or software. Moreover, the arrangement can be integrated in an electronic control unit (ECU) or, in one embodiment, can be an ECU.

### BRIEF DESCRIPTION OF THE DRAWINGS

FIG. 1 shows a flow diagram illustrating an Authenticated Boot sequence.

FIG. 2 shows a flow diagram illustrating a deterministic Authenticated Boot sequence, according to an example embodiment of the present invention.

### DETAILED DESCRIPTION OF EXAMPLE EMBODIMENTS

It will be understood that the features mentioned above and those described hereinafter can be used not only in the combination specified but also in other combinations or on their own, without departing from the scope of the present invention.

The present invention is diagrammatically illustrated in the figures by means of embodiments by way of example, and is hereinafter explained in detail with reference to the figures. It is understood that the description is in no way limiting on the scope of the present invention and is nearly an illustration of example embodiments of the present invention.

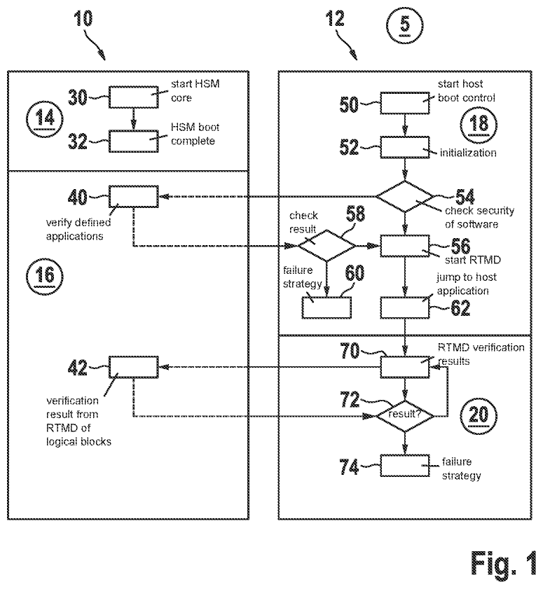

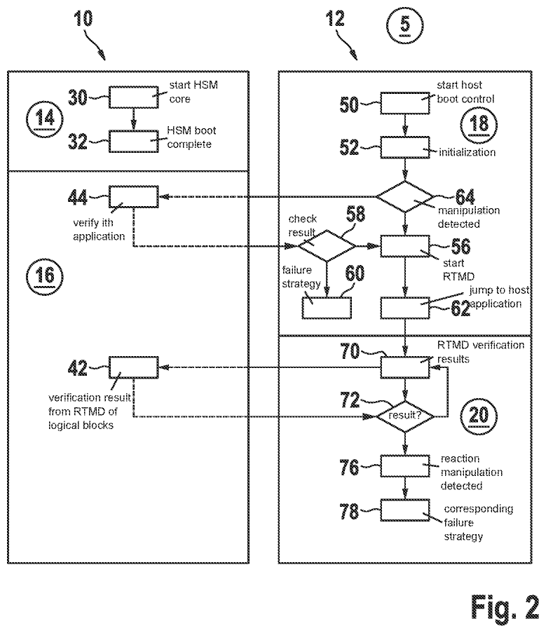

The existing Authenticated Boot sequence is shown in FIG. 1. The figures shows on the left side HSM 10 and on the right side the host 12 as components of a ECU 5. Furthermore, FIG. 2 shows the blocks HSM boot 14, HSM application 16, host boot 18 and host application 20. It is to be considered that the host 12 and HSM run in parallel, particularly start in parallel with execution.

In HSM boot 14 the steps are:

| | |
|---|---|
| step 30 | start HSM core |
| step 32 | HSM boot complete |

In HSM application the steps are:

| | |
|---|---|
| step 40 | verify defined applications |
| step 42 | verification result from RTMD of logical blocks |

In host boot 18 the steps are:

| | |
|---|---|
| step 50 | start host boot control |
| step 52 | Initialization |
| step 54 | check security of software |

If security of the corresponding software component needs to be checked, move to step 40. If not, move to step 56

| | |
|---|---|
| step 56 | start RTMD |
| step 58 | check result of step 40 |

If it is ok, move to step 56. If not, move to step 60

| | |
|---|---|
| step 60 | failure strategy |
| step 62 | jump to host application 20 |

In host application 20 the steps are:

| | |
|---|---|
| step 70 | RTMD verification results |
| step 72 | result? |

Step 70 in host application 20 calls for step 42 in HSM application 16.

If the result is ok, move to step 70. If not, move to step 74.

| | |
|---|---|
| step 74 | failure strategy. |

The steps 54 and 74 in Authenticated Boot sequence shown in FIG. 1 indicate the locations in the sequence where the proposed method offers amendments.

The present invention is an extension to Authenticated Boot sequence involving host and HSM cores. The goal is to reduce the ECU boot up time and ensure security.

RTMD (Run Time Manipulation Detection) is an existing HSM application that monitors the configured software component blocks in defined time intervals and runs in HSM application, the information/result is used by host. If a manipulation is detected by HSM in application mode of host, the proposal is to maintain the flag status to indicate this manipulation. Host and HSM can both be operated in two modes, boot mode and application mode. Host boot mode is software which is just sufficient to perform initial checks and is usually required during update or reflashing of new software. Vehicle is assumed to be in standstill when the host is in boot mode. Host application mode is when actual software is executing and vehicle is in running mode and ECU features are active. HSM in boot mode only allows a minimal set of features as full fledged HSM is available in HSM application mode.

Each software block can be assigned a block ID. The flag can be viewed as an array with index value indicating the software block ID and the value indicates if a manipulation is detected for corresponding block or not. A value set for the index indicates a manipulation detection and correspondingly a value of zero indicates no manipulation detected.

During the ECU boot up process, the host boot implementation can assess these flag values to check if any manipulation was registered. From the current options, the ECU boot up time is increased as the host always requires the HSM involvement either to perform real time computation or last result verification and comparison. In this proposal, as shown in FIG. 2, deterministic Authenticated Boot sequence, the host would first check only if the manipulation flag is set.

In comparison to FIG. 1, FIG. 2 shows the following steps:

In HSM application 16:

| | |
|---|---|
| step 44 | verify [i]th application |

In host boot 18:

| | |
|---|---|
| step 64 | manipulation detected |

If so, move to step 44. If not, move to step 56

In host application 20:

| | |
|---|---|
| step 76 | reaction manipulation detected [i] = 1 |
| step 78 | corresponding failure strategy |

As this flag setting and detection is happening in application mode, ECU boot up time remains unaffected by this action. When the ECU is booting up, the host core should only verify the flag set by application without any involvement of HSM if no manipulation is detected. Thus, in normal scenario, when no security attack is considered, host boot would just check for Boolean flag values without HSM intervention and once switched to application mode, HSM would anyways be involved to perform detection in the form of RTMD. If any manipulation is detected in application mode, the flag is set for the correspondingly affected block.

This is then verified by the host during booting. Thus, in a scenario of security attack the host can make an informed decision and involve HSM to perform a real time computation of the manipulated block as the flag consists of the information of block ID. Based on the verification result corresponding failure strategy 78 can be put in place.

The method provided according to the present invention would not interfere with ECU boot up process in event when no security attack is detected. Thus, not having an impact on boot up time yet monitoring for security attack in application mode of the host. Based on this evaluation, proposed approach ensures that the ECU boot up time remains intact and simultaneously provides the security level of Authenticated Boot.

In FIG. 2, the Manipulation detected (step 64) denotes the flag to be set in host once a manipulation is detected. This flag can be shown as an array value to indicate the storage of manipulation detection of the various software blocks. Thus, if manipulation is detected, with the software block information, host now has the ability to query the HSM to re-compute the integrity checks of the affected software block.

Each software block is assigned an ID. Flag set corresponds to this ID. So, if manipulation is detected for software block with ID 2, assuming boot host knows that software component 2 has to be rechecked by HSM.

In normal scenarios, when no security attack has occurred, the flag remains unchanged. Thus, providing the host the understanding that the HSM intervention during boot-up is not required. In the options currently available as described above, irrespective of an occurrence of a security event, HSM intervention is performed. Thus, increasing ECU boot-up time. In this proposal in scenarios where security event is not detected HSM intervention is skipped thus the boot-up remaining unaffected.

The method proposed concentrates the security during ECU boot-up and ECU boot-up time. But, as it is shown in FIG. 2, once the manipulation is detected in ECU host application a corresponding failure strategy 78 can be set in place. This is to avoid delaying of taking security measures to boot up time and taking an action as soon as the security event is detected. Some of the failure strategies can be to raise a Diagnostic Trouble Code (DTC), to send a error message on CAN bus (CAN: controller area network), to lock the security critical information like cryptographic keys, to notify the OEM by sending a log data to Telematic Control Unit (TCU) which is connected to OEM backend etc.

Another failure strategy would be to inform the driver by the infotainment system and to have the truck running only for a certain limited period of time.

Generally, the method can be performed in each ECU which is security relevant or involved in security actions as a security mechanism. As these ECUs can be deployed in various in-vehicular domains such as power-train, chassis, infotainment, central gateway etc., the security mechanism proposed is highly beneficial for these products, especially for ECUs with stringent Boot-up time requirements.

What is claimed is:

1. A method for booting an electronic control unit (ECU), the ECU including a host interacting with a Hardware Security Module (HSM), the method comprising:
checking, by the HSM, at least one software component;
based on a manipulation being detected, sending, by the host, a request to HSM to check whether the manipulation has occurred; and
deciding by the host whether an intervention is necessary.

2. The method according to claim 1, wherein the manipulation is detected by checking a bit change in memory address range of the at least one software component or by checking a checksum on an address of the at least one software component.

3. The method according to claim 1, wherein the host queries the HSM to recompute integrity checks of the software component.

4. The method according to claim 1, wherein, when the manipulation is detected, the host sets a flag.

5. The method according to claim 4, wherein the flag is an array value.

6. The method according to claim 1, wherein the host requests Run Time Manipulation Detection (RTMD) verification results from HSM.

7. The method according to claim 1, wherein the intervention causes a failure strategy to be performed.

8. The method according to claim 7, wherein the failure strategy is a strategy selected from a group consisting of: raising a Diagnostic Trouble Code (DTC), sending a error message on CAN bus, locking security critical information including cryptographic keys, notifying a producer by sending a log data to a Telematic Control Unit (TCU) which is connected to a producer backend, informing a driver by an infotainment system, and having a truck run for only a certain limited period of time.

9. The method according to claim 1, whereby the HSM uses a cryptographic algorithm to verify integrity and authenticity of the at least one software component.

10. An arrangement for booting an ECU, the ECU including a host interacting with a Hardware Security Module (HSM), the arrangement being configured to:
check, by the HSM, at least one software component;
based on a manipulation being detected, send, by the host, a request to HSM to check whether the manipulation has occurred; and
decide by the host whether an intervention is necessary.
